(19) United States
(12) Patent Application Publication
(10) Pub. No.: US 2017/0076241 A1
(43) Pub. Date: Mar. 16, 2017

(54) METHOD AND SYSTEM FOR SELECTING CROWD WORKFORCE FOR PROCESSING TASK

(71) Applicant: XEROX CORPORATION, Norwalk, CT (US)

(72) Inventors: Shruti Kunde, Mumbai (IN); Chithralekha Balamurugan, Pondicherry (IN); Deepthi Chander, Cochin (IN); Avantika Gupta, Vrindavan (IN)

(21) Appl. No.: 14/849,911

(22) Filed: Sep. 10, 2015

(51) Int. Cl. G06Q 10/06; G06Q 50/00; H04L 29/08

(52) U.S. Cl. CPC G06Q 10/063112; H04L 67/10; G06Q 50/01

(57) ABSTRACT

The disclosed embodiments illustrate methods and systems for selecting a crowd workforce for processing a task. The method includes receiving a request from a requestor to process the task. The method further includes generating a set of rules based on at least one or more attributes associated with the task. The method further includes selecting a first set of crowd workers, from one or more crowd workers, based on at least a triggering of one or more rules from the set of rules. The triggering of the one or more rules is based on at least a set of threshold values associated with the one or more crowd workers. The method further includes displaying a resource graph on a display screen of a requestor-computing device associated with a requestor, where the resource graph represents at least the first set of crowd workers.

### TECHNICAL FIELD

The presently disclosed embodiments are related, in general, to crowdsourcing. More particularly, the presently disclosed embodiments are related to methods and systems for selecting a crowd workforce for processing one or more tasks.

### BACKGROUND

Crowdsourcing platforms provide an online job market. The one or more crowd workers may connect to the crowdsourcing platforms over a network and thereafter select and execute one or more tasks posted on the crowdsourcing platforms by requestors. The crowdsourcing platforms usually select a pool of crowd workers, from the one or more crowd workers, without keeping the requestors in the loop. Therefore, the requestors may not be aware of the type of the one or more crowd workers that the crowdsourcing platforms have employed to execute the one or more tasks posted by the requestors. This may further lead to an uncertain situation, at the requestors' end, about whether the Service Level Agreements (SLAs) associated with the one or more tasks will be met.

### SUMMARY

According to embodiments illustrated herein, there is provided a method for selecting a crowd workforce for processing a task. The method includes receiving, by one or more processors, the task and one or more attributes associated with the task from a requestor-computing device. The task is associated with one or more attributes. The method further includes generating, by the one or more processors, a set of rules based on at least the one or more attributes associated with the task. The set of rules are stored in a hierarchal data structure based on at least a priority associated with each of the set of rules. The method further includes selecting, by the one or more processors, a first set of crowd workers, from one or more crowd workers, based on at least a triggering of one or more rules from the set of rules. The triggering of the one or more rules is based on at least the hierarchal data structure and at least a set of threshold values associated with the one or more crowd workers. The method further includes displaying, by the one or more processors, a resource graph on a display screen of the requestor-computing device associated with a requestor, wherein the resource graph represents at least the first set of crowd workers. The method further includes enabling, by the one or more processors, the requestor to select a second set of crowd workers from the first set of crowd workers, wherein the requestor utilizes the resource graph for the selection of the second set of crowd workers. The second set of crowd workers corresponds to the crowd workforce, who processes the task.

According to embodiments illustrated herein, there is provided a system for selecting a crowd workforce for processing a task. The system includes one or more processors configured to receive the task and one or more attributes associated with the task from a requestor-computing device. The task is associated with one or more attributes. The one or more processors are further configured to generate a set of rules based on at least the one or more attributes associated with the task. The set of rules are stored in a hierarchal data structure based on at least a priority associated with each of the set of rules. The one or more processors are further configured to select a first set of crowd workers, from one or more crowd workers, based on at least a triggering of one or more rules from the set of rules. The triggering of the one or more rules is based on at least the hierarchal data structure and at least a set of threshold values associated with the one or more crowd workers. The one or more processors are further configured to display a resource graph on a display screen of the requestor-computing device associated with a requestor, wherein the resource graph represents at least the first set of crowd workers. The one or more processors are further configured to enable the requestor to select a second set of crowd workers from the first set of crowd workers, wherein the requestor utilizes the resource graph for the selection of the second set of crowd workers. The second set of crowd workers corresponds to the crowd workforce, who processes the task.

According to embodiments illustrated herein, there is provided a computer program product for use with a computer, the computer program product comprising a non-transitory computer readable medium, wherein the non-transitory computer readable medium stores a computer program code for selecting a crowd workforce for processing a task. The computer program code is executable by one or more processors to receive an input, indicative of at least a request to process the task, from a requestor-computing device. The task is associated with one or more attributes. The computer program code is further executable by one or more processors to generate a set of rules based on at least the one or more attributes associated with the task. The set of rules are stored in a hierarchal data structure based on at least a priority associated with each of the set of rules. The computer program code is further executable by one or more processors to select a first set of crowd workers, from one or more crowd workers, based on at least a triggering of one or more rules from the set of rules. The triggering of the one or more rules is based on at least the hierarchal data structure and at least a set of threshold values associated with the one or more crowd workers. The computer program code is further executable by one or more processors to display a resource graph on a display screen of the requestor-computing device associated with a requestor, wherein the resource graph represents at least the first set of crowd workers. The computer program code is further executable by one or more processors to enable the requestor to select a second set of crowd workers from the first set of crowd workers, wherein the requestor utilizes the resource graph for the selection of the second set of crowd workers. The second set of crowd workers corresponds to the crowd workforce, who processes the task.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment, in which various embodiments can be implemented;

FIG. 2 is a block diagram that illustrates a system for selecting a crowd workforce for processing a task, in accordance with at least one embodiment;

FIG. 3 is a flowchart illustrating a method for selecting a crowd workforce for processing a task, in accordance with at least one embodiment;

FIG. 4 is a block diagram of a hierarchal data structure illustrating a hierarchal set of rules, in accordance with at least one embodiment;

FIG. 5 is an illustrative example displaying a resource graph, in accordance with at least one embodiment; and

FIG. 6 is a block diagram illustrating an example graphical user interface (GUI) utilized by a requestor, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example”, and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “computing device” refers to a device including one or more processors/microcontrollers and/or any other electronic components, or a device or a system that performs one or more operations according to one or more programming instructions/codes. Examples of the computing device may include, but are not limited to, a desktop computer, a laptop, a personal digital assistant (PDA), a mobile device, a smartphone, a tablet computer (e.g., iPad® and Samsung Galaxy Tab®), and/or the like.

“Crowdsourcing” refers to a distribution of tasks and obtaining needed services by soliciting participation of loosely defined groups of individual crowd workers. A group of crowd workers may include, for example, individuals responding to a solicitation posted on a certain website such as, but not limited to, Amazon Mechanical Turk, Crowd Flower, or Mobile Works.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms include, but are not limited to, Amazon Mechanical Turk, Crowd Flower, or Mobile Works.

A “task” refers to a project, a service and/or a job that may be performed by a crowd worker. The task may include instructions about how to perform the task. Further, the task may be associated one or more attributes. For examples, one or more attributes of a task may include, but are not limited to, a type of the task, a skill set required to process the task, a day of submitting the task, a time in the day of submitting the task, a cost of the task, and so forth.

A “requestor” refers to an individual or an entity such as an organization or a business group, who may post one or more tasks on a crowdsourcing platform. The requestor may further transmit one or more attributes such as a Service Level Agreement (SLA) associated with the one or more tasks. In an embodiment, the requestor may offer an incentive to one or more crowd workers in exchange of processing the one or more tasks.

A “Service Level Agreement (SLA)” refers to a set of terms and conditions in a contract that may be associated with a task posted by a requestor. In an embodiment, the SLA may state expectations agreed upon by a crowd worker or a crowdsourcing platform with the requestor. For example, a SLA associated with a task may include a task completion time, an accuracy, a percentage of the task to be completed in a predefined time, an expected quality of the task, and a remuneration associated with the task.

A “crowd worker” refers to an individual, who may perform a task that generate data that contributes to a defined result. According to the present disclosure, the crowd worker includes, but is not limited to, a satellite center employee, a rural business process outsourcing (BPO) firm employee, a home-based employee, or an internet-based employee. The crowd worker may perform the crowdsourcing tasks using various types of devices such as, but not limited to, a laptop, a mobile phone, a PDA, a tablet, a phablet, and the like. Hereinafter, the terms “crowd worker”, “crowdworker”, “remote worker”, “worker”, “crowd workforce”, and “crowd” may be used interchangeably. In an embodiment, the crowd workforce may include at least one crowd worker.

A “set of rules” refers to one or more conditions, principles, or regulations, which may be utilized by a computing device to filter out a set of crowd workers from one or more crowd workers. In an embodiment, the set of rules may be generated based on at least one or more attributes associated with a task and one or more components such as Constructs (e.g., IF, THEN, AND, and OR), Objects (e.g., crowd worker, task, and requestor), Operations (e.g., Assert, Set, Average, Min, Max, and/or the like), and Operators (<,>,>=,<=, etc.). For example, IF (Worker [symbol] worker_id <WORKER_ID> [symbol] session_duration<WORKER_SESSION_TIME>) AND (Task [symbol] task_id<TASK_ID> [symbol] session_duration<TASK_SESSION_DURATION>) THEN (Assert(Worker.session_duration>=Task.session_duration) with some probability)

A “hierarchal data structure” refers to an arrangement of a plurality of rules in a tree like structure based on at least a priority associated with each of the plurality of rules. In an embodiment, the hierarchal data structure may represent at least a sequence of triggering of the plurality of rules.

A “priority” refers to a fact or a condition of being treated or regarded as more important than others. In an embodiment, the priority may comprise one or more ratings such as, but not limited to, “high”, “medium”, or “low” assigned to one or more rules. In another embodiment, the priority may comprise one or more numerical values representing the one or more ratings such as, but not limited to, “1”, “2”, or “3”, wherein rating “1” may be assigned corresponding to a most important rules and rating “3” may be assigned corresponding to a least important rules, or vice versa. Hereinafter, “preference” and “priority” may be interchangeably used. In an embodiment, rank may correspond to priority.

A “set of threshold values” refers to one or more numerical values associated with one or more crowd workers, which may be utilized to trigger one or more rules from a set of rules, which may further lead to selection of a set of crowd workers from the one or more crowd workers.

A “historical data” refers to a statistical data of a processing of one or more tasks by one or more crowd workers over a period of time. In an embodiment, the historical data may comprise one or more performance characteristics associated with each of the one or more crowd workers. The one or more performance characteristics associated with a crowd worker may include a qualification of the crowd worker, a skill set of the crowd worker, a count of tasks completed by the crowd worker in past, an average time taken by the crowd worker to complete each of the count of tasks, a quality of work associated with each of the count of tasks, an availability of the crowd worker on a particular day, a count of sessions associated with the crowd worker on the particular day, demographical attributes associated with the crowd worker, and a remuneration earned for each of the count of tasks by the crowd worker.

“Task accuracy” refers to a ratio of a number of correct responses to a total number of responses provided by a crowd worker for one or more tasks attempted by the crowd worker. For example, if a worker attempts 10 tasks and provides correct responses for 7 tasks, the task accuracy of the worker is 0.7 (i.e., 7/10). In an embodiment, the task accuracy may correspond to an average accuracy score attained by one or more crowd workers who attempt a particular task. For example, four workers attempt a task and attain accuracy scores of 0.5, 0.6, 0.7, and 0.8. In this scenario, the task accuracy for the particular task is the average of the accuracy scores of the individual workers, i.e., 0.65 (i.e., (0.5+0.6+0.7+0.8)/4). Thus, a person skilled in the art would appreciate that the term “task accuracy” may refer to the accuracy score attained by a worker who attempts multiple tasks and alternatively the task accuracy may be task specific and correspond to the average of task accuracy scores attained by multiple workers who attempt a particular task.

“Task Completion time” refers to a time consumed by a worker to complete a task.

A “remuneration” refers to a reward paid to a crowd worker for completing a task posted on a crowdsourcing platform server. In an embodiment, examples of the reward may include, but are not limited to, a monetary compensation, lottery tickets, gift items, shopping vouchers, and discount coupons.

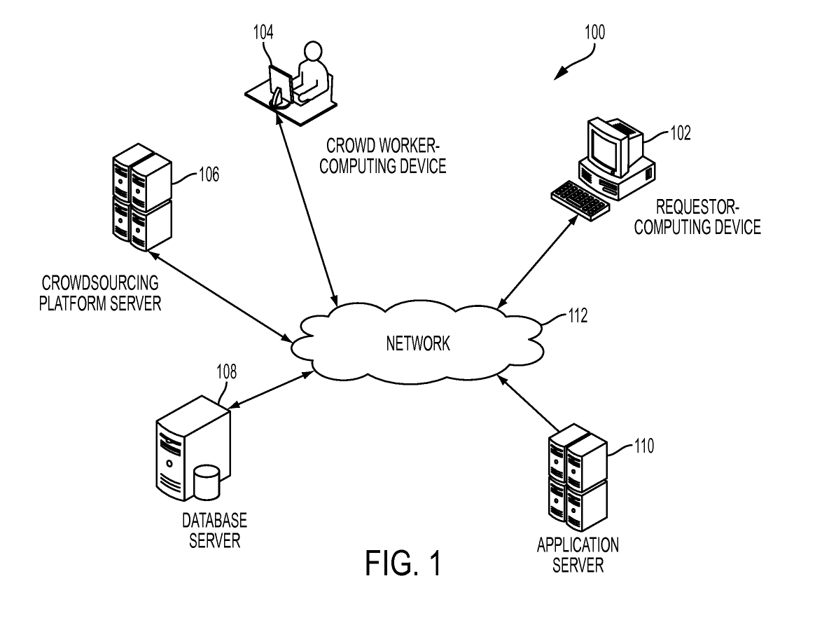

FIG. 1 is a block diagram of a system environment 100, in which various embodiments can be implemented. The system environment 100 includes a requestor-computing device 102, a crowd worker-computing device 104, a crowdsourcing platform server 106, a database server 108, an application server 110, and a network 112. Various devices in the system environment 100 may be interconnected over the network 112. FIG. 1 shows, for simplicity, one requestor-computing device 102, one crowd worker-computing device 104, one crowdsourcing platform server 106, one database server 108, and one application server 110. However, it will be apparent to a person having ordinary skill in the art that the disclosed embodiments may also be implemented using multiple requestor-computing devices, multiple crowd worker-computing devices, multiple crowdsourcing platform servers, multiple database servers, and multiple application servers.

The requestor-computing device 102 may refer to a computing device that includes one or more processors and one or more memories. The one or more memories may include computer readable codes and instructions that may be executable by the one or more processors to perform predetermined operations. In an embodiment, the requestor-computing device 102 may be utilized by a requestor such as an employee of an organization. In another embodiment, the requestor may be an employee of another organization, who may provide a consultation service to the organization. The requestor may utilize the requestor-computing device 102 to post/transmit/share one or more tasks and one or more attributes associated with the one or more tasks on a crowdsourcing platform server 106 or the database server 108. In an embodiment, the requestor may be connected to a crowdsourcing platform, such as a crowdsourcing platform server 106 over the network 112 to post the one or more tasks and the associated one or more attributes. In an embodiment, the one or more attributes associated with the crowdsourcing task may comprise, but are not limited to, a type of the crowdsourcing task, a skill set required to process the crowdsourcing task, and a Service Level Agreement (SLA) associated with the crowdsourcing task. In an embodiment, the requestor may provide one or more preferences for the one or more attributes associated with the one or more tasks.

In an embodiment, the requestor may further utilize the requestor-computing device 102 to provide one or more inputs pertaining to a selection of a crowd workforce, who may work upon the one or more tasks posted by the requestor.

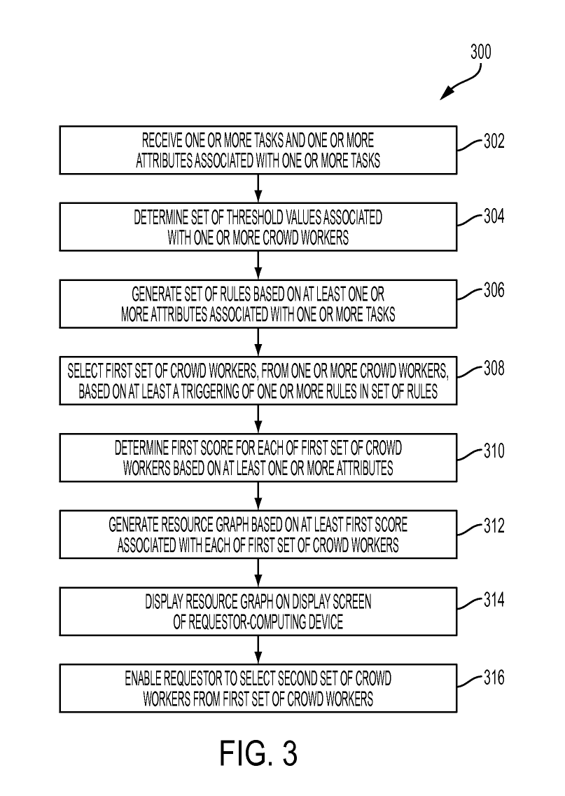

Further, in an embodiment, the requestor may utilize a graphical user interface (GUI), presented on the requestor-computing device 102, to view a resource graph displaying a first set of crowd workers. In an embodiment, the first set of crowd workers may have been selected from one or more crowd workers by the application server 110. An embodiment of the selection of the first set of crowd workers has been explained later in conjunction with FIG. 3. The requestor may further utilize the resource graph to select a second set of crowd workers (i.e., the crowd workforce), who may work upon the one or more tasks. An embodiment of the selection of the second set of crowd workers has been explained later in conjunction with FIG. 3.

After selecting the second set of crowd workers, the requestor may utilize the requestor-computing device 102 to communicate/transmit/share the one or more tasks and the associated one or more attributes to the second set of crowd workers over the network 112. Further, in an embodiment, the requestor may receive one or more responses, pertaining to the one or more tasks, from the crowd worker-computing device 104 associated with each of the second set of crowd workers. In an embodiment, the requestor may validate the one or more responses submitted by the second set of crowd workers. After validating, the requestor may initiate payment to the second set of crowd workers based on at least the validation of the one or more responses. For example, a requestor transmits a task to a crowd worker on May 25, 2015. The task includes 10 sub-tasks. The requestor agrees to pay USD 100 for the task, when correct responses to the task are submitted latest by May 30, 2015. The crowd worker processes the task and submits the responses to the requestor on May 28, 2015. The requestor validates the responses and finds nine correct responses and one incorrect response. Based on the validation, the requestor pays USD 90 to the crowd worker.

The requestor-computing device 102 may be implemented as a variety of computing devices such as a desktop, a computer server, a laptop, a personal digital assistant (PDA), a tablet computer, a mobile phone, a smartphone, and the like.

The crowd worker-computing device 104 may refer to a computing device including one or more processors and one or more memories. The one or more memories may include computer readable codes and instructions that may be executable by the one or more processors to perform predetermined operations. In an embodiment, the crowd worker-computing device 104 may be utilized by a crowd worker. The crowd worker may utilize the crowd worker-computing device 104 to connect to the crowdsourcing platform server 106 over the network 112. Thereafter, in an embodiment, the crowd worker may utilize the crowd worker-computing device 104 to select the one or more tasks posted by the requestor on the crowdsourcing platform. In another embodiment, the crowd worker may utilize the crowd worker-computing device 104 to receive the one or more tasks transmitted/communicated by the requestor or the crowdsourcing platform server 106 over the network 112. Further, the crowd worker may utilize the crowd worker-computing device 104 to work upon the one or more selected tasks or the one or more received tasks. After processing the one or more tasks, the crowd worker may utilize the crowd worker-computing device 104 to submit the one or more responses of the one or more tasks either to the crowdsourcing platform server 106 or to the requestor-computing device 102 over the network 112. The crowd worker may provide the one or more responses to the one or more tasks using one or more input devices (e.g., keyboard, touch-interface, gesture-recognition, etc.) associated with the crowd worker-computing device 104. In an embodiment, the crowd worker may utilize the crowd worker-computing device 104 to communicate with the requestor over the network 112.

The crowd worker-computing device 104 may be implemented as a variety of computing devices such as a laptop, a personal digital assistant (PDA), a tablet computer, a mobile phone, a smartphone, a phablet, and the like.

The crowdsourcing platform server 106 refers to a computing device that may be configured to host one or more crowdsourcing platforms. In an embodiment, the crowdsourcing platform server 106 may present a graphical user interface (GUI) on a display screen of the requestor-computing device 102 over the network 112, when the requestor may have logged on the crowdsourcing platform. The requestor may utilize the GUI to post/share the one or more tasks and the associated one or more attributes on to the crowdsourcing platform. The crowdsourcing platform server 106 may receive the one or more tasks posted by the requestor. Thereafter, the crowdsourcing platform server 106 may display the one or more tasks to the one or more crowd workers, who may be connected to the crowdsourcing platform server 106 over the network 112. Further, in an embodiment, the crowdsourcing platform server 106 may facilitate the one or more crowd workers to select and/or download and thereafter, work upon the one or more tasks. Further, in an embodiment, the crowdsourcing platform server 106 may receive the one or more responses pertaining to the one or more tasks from the one or more crowd workers over the network 112.

In an embodiment, the crowdsourcing platform server 106 may facilitate a direct communication between the requestor and the one or more crowd workers over the network 112. In an embodiment, the crowdsourcing platform server 106 may facilitate the direct communication to allow the requestor and the one or more crowd workers to negotiate terms and conditions of the Service Level Agreement (SLA) associated with the one or more tasks.

The crowdsourcing platform server 106 may be realized through various types of application servers such as, but not limited to, Java application server, .NET framework, and Base4 application server.

The database server 108 may refer to a computing device that may store the one or more tasks, in accordance with at least one embodiment. In an embodiment, the database server 108 may store the one or more attributes associated with the one or more tasks. In an embodiment, the database server 108 may store a historical data associated with each of the one or more crowd workers. The historical data of a crowd worker may comprise one or more performance characteristics associated with the crowd worker. For example, one or more performance characteristics of a crowd worker may include one or more of, but are not limited to, a qualification of the crowd worker, a skill set associated with the crowd worker, a count of tasks completed by the crowd worker in the past, an average time taken by the crowd worker to complete each of the count of tasks, and a quality of work associated with each of the count of tasks. Further, the one or more performance characteristics of the crowd worker may include an availability of the crowd worker on a particular day, a count of sessions associated with the crowd worker on the particular day, a set of demographical attributes (e.g., name, age, location, acquaintance with other crowd workers, and/or the like) associated with the crowd worker, and a remuneration charged for each of the count of tasks by the crowd worker. In an embodiment, the database server 108 may obtain the one or more performance characteristics pertaining to the crowd worker from various sources such as, but not limited to, social networking websites, databases of various organizations that may provide a rightful authentication to access information pertaining to the crowd worker, and the crowdsourcing platform. Further, in an embodiment, the database server 108 may store the one or more responses, pertaining to the one or more tasks, submitted by the one or more crowd workers.

In an embodiment, the database server 108 may be communicatively coupled with the network 112. In an embodiment, the database server 108 may be configured to transmit or receive the one or more tasks/attributes/responses/instructions to/from one or more devices such as the requestor-computing device 102, the crowd worker-computing device 104, the crowdsourcing platform server 106, or the application server 110 over the network 112.

For querying the database server 108, one or more querying languages may be utilized such as, but are not limited to, SQL, QUEL, DMX and so forth. In an embodiment, the crowdsourcing platform server 106 may connect to the database server 108 using one or more protocols such as, but not limited to, ODBC protocol and JDBC protocol. Further, the database server 108 may be realized through various technologies such as, but not limited to, Microsoft® SQL server, Oracle, and My SQL.

It will be apparent to a person skilled in the art that the functionalities of the database server 108 may be incorporated into the crowdsourcing platform server 106, without departing from the scope of the disclosure.

The application server 110 may refer to a computing device or a software framework that may provide a generalized approach to create the application-server implementation. In an embodiment, the functionalities of the application server 110 may be dedicated to the efficient execution of procedures such as, but not limited to, programs, routines, or scripts stored in one or more memories for supporting its applied applications. In an embodiment, the requestor may utilize the requestor-computing device 102 to access/connect the application server 110 to upload the one or more tasks and the associated one or more attributes. In an embodiment, the application server 110 may further upload the one or more tasks to the crowdsourcing platform server 106. In an embodiment, the application server 110 may act as a middleware for the requestor-computing device 102 to upload the one or more tasks. In an embodiment, the application server 110 may include an application interface or a plugin of the crowdsourcing platform server 106 that may enable the application server 110 to upload the one or more tasks to the crowdsourcing platform server 106. Further, the application interface or the plugin may further enable the access to the information pertaining to the one or more crowd workers registered on the crowdsourcing platform server 106.

In an embodiment, the application server 110 may present a web interface on the requestor-computing device 102 that may enable the requestor to submit the one or more tasks and the associated one or more attributes. Further, the web interface in an embodiment, the application server 110 may receive an input, from the requestor-computing device 102, pertaining to the selection of the crowd workforce. In an embodiment, the input may further correspond to defining one or more predefined parameters pertaining to the selection of the crowd workforce. For example, one or more predefined parameters may include one or more of, but are not limited to, an availability of a crowd worker, a count of tasks to be completed by the crowd worker, a time taken for completing the count of tasks, and a task execution time of the crowd worker. Further, in an embodiment, the application server 110 may receive the one or more preferences for the one or more predefined parameters from the requestor-computing device 102. In another embodiment, the application server 110 may utilize a pre-stored one or more preferences. In another embodiment, the application server 110 may utilize historical record of the requestor to determine the one or more preferences. For example, a first requestor has preferred an availability of a crowd worker on Friday for seven tasks out of 10 tasks as compared to an affordability of the crowd worker. In such a case, the application server 110 may assign a higher priority to the availability of the crowd worker and a lower priority to the affordability of the crowd worker.

Further, in an embodiment, the application server 110 may extract the historical data from the database server 108. Thereafter, the application server 110 may determine a set of threshold values for each crowd worker based on at least the historical data associated with the crowd worker and the one or more attributes associated with the one or more tasks. In an embodiment, each threshold value, from the set of threshold values, may be determined corresponding to a predefined parameters. For example, a threshold value may be determined based on at least a probability of availability a crowd worker on a particular day (e.g., Monday). The determination of the set of threshold values has been explained later in conjunction with FIG. 3.

Further, in an embodiment, the application server 110 may be configured to generate a set of rules. The set of rules may be determined based on at least the requirements (e.g., the one or more attributes) of the requestor such as the SLAs associated with the one or more tasks. Further, each of the set of rules are stored in a hierarchal data structure based on at least a priority associated with each of the set of rules. The determination of the set of rules and the priority of each of the set of rules have been explained later in conjunction with FIG. 3.

After determining the set of rules and the set of threshold values, the application server 110 may be configured to select a first set of crowd workers, from the one or more crowd workers, based on at least a triggering of one or more rules from the set of rules. In an embodiment, the one or more rules are triggered based on at least the hierarchal data structure and the set of threshold values associated with the one or more crowd workers. The selection of the first set of crowd workers has been explained later in conjunction with FIG. 3.

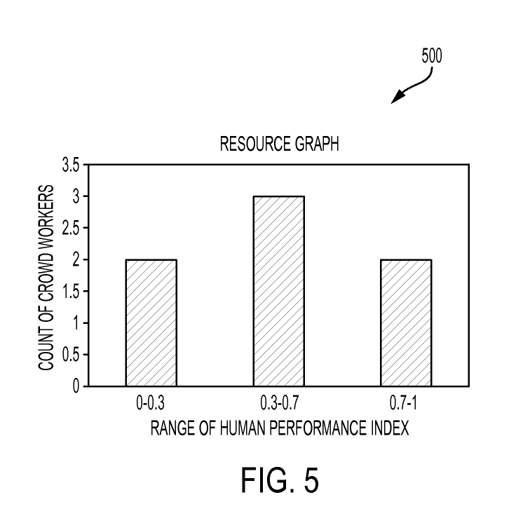

After selecting the first set of crowd workers, the application server 110 may be configured to determine a first score for each of the first set of crowd workers. In an embodiment, the first score may correspond to a Human Performance Index (HPI), which may be indicative of whether a first crowd worker, from the first set of crowd workers, is more efficient than the remaining first crowd workers from the first set of crowd workers. The first score is determined based on at least the one or more attributes provided by the requestor. The determination of the first score has been explained later in conjunction with FIG. 3. Thereafter, the application server 110 may be configured to generate a resource graph based on at least the first score associated with each of the first set of crowd workers. The generation of the resource graph has been explained later in conjunction with FIG. 3 and FIG. 5.

After generating the resource graph, the application server 110 may display the resource graph on the requestor-computing device 102. The application server 110 may further enable the requestor to select the second set of crowd workers from the first set of crowd workers. The requestor may utilize the resource graph and the first score associated with each of the first set of crowd workers to select the second set of crowd workers. After selecting the second set of crowd workers, the requestor may communicate/transmit the one or more tasks to the second set of crowd workers. Further, the requestor may receive the one or more responses of the one or more tasks from the crowd worker-computing device 104 associated with each of the second set of crowd workers over the network 112.

A person having ordinary skill in the art will understand that the scope of the disclosure is not limited to the crowdsourcing platform server 106, the database server 108 or the application server 110 as a separate entity. In an embodiment, the functionalities of the crowdsourcing platform server 106, the database server 108, or the application server 110 may be combined into a single server, without limiting the scope of the disclosure.

The network 112 corresponds to a medium through which content and messages flow between various devices of the system environment 100 (e.g., the crowdsourcing platform server 106 the requestor-computing device 102, the crowd worker-computing device 104, and the database server 108). Examples of the network 112 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 112 in accordance with various wired and wireless communication protocols such as Transmission Control Protocol and Internet Protocol (TCP/IP), User Datagram Protocol (UDP), and 2G, 3G, or 4G communication protocols.

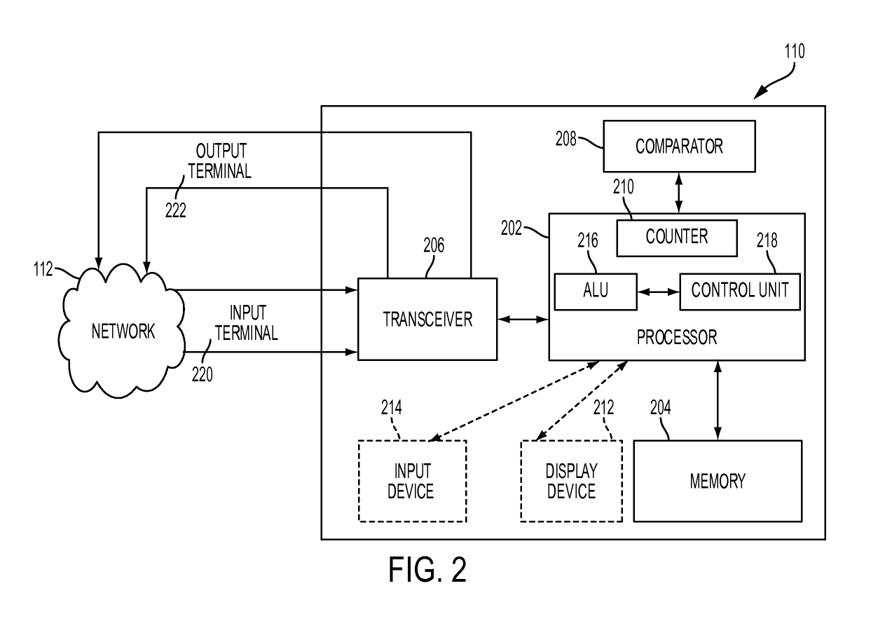

FIG. 2 is a block diagram that illustrates a system 110 for selecting the crowd workforce for processing the one or more tasks, in accordance with at least one embodiment. In an embodiment, the system 110 may correspond to the crowdsourcing platform server 106 or the application server 110. For the purpose of ongoing description, the system 110 is considered as the application server 110. However, the scope of the disclosure should not be limited to the system 110 as the application server 110. The system 110 may also be realized as the crowdsourcing platform server 106, without departing from the spirit of the disclosure. Further, in an embodiment, the system 110 may be realized as a server, such that the functionalities of the crowdsourcing platform server 106, the database server 108, or the application server 110 may be combined into a single server.

The system 110 includes one or more processors, such as a processor 202, one or more memories, such as a memory 204, one or more transceiver, such as a transceiver 206, one or more comparators, such as a comparator 208, one or more display devices, such as a display device 212, one or more input devices, such as an input device 214. The transceiver 206 is connected to the network 112 through the input terminal 220 and the output terminal 222.

The processor 202 may be configured to execute one or more sets of instructions stored in the memory 204. The processor 202 may be coupled to the memory 204, the transceiver 206, the comparator 208, the display device 212, and the input device 214. The processor 202 may further comprise an arithmetic logic unit 216 and a control unit 218. The arithmetic logic unit (ALU) 216 may be coupled to the control unit 218. The ALU 216 may be configured to perform one or more mathematical and logical operations and the control unit 218 may control the operation of the ALU 216. Further, the processor 202 may comprise one or more counters such as a counter 210. Though, the counter 210 is implemented within the processor 202 in FIG. 2, a person skilled in the art will appreciate the counter 210 to be implemented as independent from the processor 202 without departing from the scope of the disclosure. The processor 202 may execute a set of instructions/programs/codes/scripts stored in the memory 204 to perform the one or more operations. The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store the one or more sets of instructions. In an embodiment, the memory 204 may include one or more buffers (not shown). The one or more buffers may store at least one or more of, but not limited to, the one or more tasks, the one or more attributes associated with the one or more tasks, and the historical data associated with the one or more crowd workers. Some of the commonly known memory implementations include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations. It will be apparent to a person having ordinary skill in the art that the one or more instructions stored in the memory 204 may enable the hardware of the system 110 to perform the operations associated with the crowdsourcing platform server 106 or the application server 110.

The transceiver 206 may be operable to communicate with the one or more devices, such as the requestor-computing device 102 and the crowd worker-computing device 104 and/or one or more servers, such as the crowdsourcing platform server 106 or the database server 108 over the network 112. The transceiver 206 receives and transmits the historical data associated with the one or more crowd workers, the one or more tasks, and the associated one or more attributes from/to various components of the system environment 100 (e.g., the requestor-computing device 102, the crowd worker-computing device 104, the crowdsourcing platform server 106, and the database server 108,) over the network 112 through the input terminal 220 and the output terminal 222. Examples of the transceiver 206 may include, but are not limited to, an antenna, an Ethernet port, a USB port, or any other port that can be configured to receive and transmit data. The transceiver 206 receives and transmits the one or more tasks, the one or more attributes, and the historical data in accordance with the various communication protocols, such as, TCP/IP, UDP, and 2G, 3G, or 4G communication protocols through the input terminal 220 and the output terminal 222, respectively.

The comparator 208 is configured to compare at least two input signals to generate an output signal. In an embodiment, the output signal may correspond to either “1” or “0.” In an embodiment, the comparator 208 may generate output “1” if the value of a first signal (from the at least two signals) is greater than the value of a second signal (from the at least two signals). Similarly, the comparator 208 may generate an output “0” if the value of the first signal is less than the value of the second signal. In an embodiment, the comparator 208 may be realized through either software technologies or hardware technologies known in the art. Though, the comparator 208 is depicted as independent from the processor 202 in FIG. 1, a person skilled in the art will appreciate that the comparator 208 may be implemented within the processor 202 without departing from the scope of the disclosure.

The display device 212 may comprise suitable logic, circuitry, interfaces, and/or code that may be operable to render a display. In an embodiment, the display device 212 may be realized through several known technologies such as, Cathode Ray Tube (CRT) based display, Liquid Crystal Display (LCD), Light Emitting Diode (LED) based display, Organic LED display technology, and Retina display technology. In addition, in an embodiment, the display device 212 may be capable of receiving the one or more inputs from the user. In such a scenario, the display device 212 may be a touch screen that enables the user to provide the one or more inputs. In an embodiment, the touch screen may correspond to at least one of a resistive touch screen, capacitive touch screen, or a thermal touch screen. In an embodiment, the display device 212 may receive input through a virtual keypad, a stylus, a gesture, and/or touch based input.

The input device 214 may comprise suitable logic, circuitry, interfaces, and/or code that may be operable to receive one or more inputs from the requestor. The input device 214 may be operable to communicate with the processor 202. Examples of the input devices may include, but are not limited to, a touch screen, a keyboard, a mouse, a joystick, a microphone, a camera, a motion sensor, a light sensor, and/or a docking station.

An embodiment of the operation of the system 110 for selecting the crowd workforce for processing the one or more tasks has been explained further in conjunction with FIG. 3.

FIG. 3 is a flowchart illustrating a method for selecting the crowd workforce for processing the one or more tasks, in accordance with at least one embodiment. The flowchart 300 has been described in conjunction with FIG. 1 and FIG. 2.

At step 302, the one or more tasks and the one or more attributes associated with the one or more tasks are received. In an embodiment, the processor 202 may receive the one or more tasks and the one or more attributes associated with the one or more tasks from the requestor-computing device 102. In another embodiment, the processor 202 may extract the one or more tasks and the associated attributes from the database server 108. The one or more tasks may correspond to one or more projects/services/activities that may be performed by the one or more crowd workers. In an embodiment, the one or more tasks may include instructions about how to perform the one or more tasks. Further, the one or more tasks may comprise data that may be processed by the one or more crowd workers. For example, data associated with a task may include an image data or a text data in an analog form and/or a digital form retained in at least one of an electronic form or a printed form. Each of the electronic form or the printed form may include one or more images, symbols, text, line art, blank, or non-printed regions, etc. In an embodiment, the electronic data may be obtained by scanning a corresponding printed document containing the electronic data. Further, the electronic data may be stored in various file formats such as JPG or JPEG, GIF, TIFF, PNG, BMP, RAW, PSD, PSP, PDF, and the like. In an embodiment, the one or more tasks may comprise one or more of, but are not limited to, data translation, data transcription, image tagging, article writing, website testing, data verification, logo design, business card design, ads, video, image tagging, and website design.

Further, in an embodiment, the one or more attributes associated with the one or more tasks may comprise one or more of, but are not limited to, a type of the one or more tasks, a skill set required to process each of the one or more tasks, and a Service Level Agreement (SLA) associated with each of the one or more tasks. The SLA associated with a task may include at least a task completion time, an accuracy, a count of tasks to be completed in a predefined time, an expected quality of the task, and a remuneration associated with the task. For example, an SLA associated with tasks has been shown in Table 1:

TABLE 1
Illustration of SLA associated with tasks.

| | Task | | % of tasks to | Expected | Task |
|---|---|---|---|---|---|
| | Completion | Accu- | be completed in | quality | remu- |
| | Time | racy | a predefined | of | neration |
| Task | (hours) | (%) | time | task | (USD) |
| Task-1 | 10 | 85 | 75 | 90 | 25 |
| Task-2 | 9 | 80 | 80 | 95 | 20 |
| Task-3 | 15 | 95 | 85 | 95 | 35 |

Further, in an embodiment, the one or more tasks may comprise one or more sub-tasks. For example, a task may comprise a digital data, such as a filled form. The filled form may comprise different fields. The filled form may be divided such that one or more fields of the form may constitute a sub-task. Thus, the sub-task may be defined as a set of fields that belong to a single conceptual division of the filled form. In an embodiment, a unique ID is assigned to each sub-task (segregated from the task). In an embodiment, one or more fields/portions that form a sub-task are so selected that one cannot gain meaningful privacy revealing information from the one or more fields/portions included in a micro-task. Further, in an embodiment, each of the one or more sub-tasks may be associated with its own SLA. For example, a task comprises five sub-tasks. A time of submitting responses pertaining to each sub-task is different (e.g., Monday, Tuesday, Wednesday, Thursday, and Friday). Further, an incentive for processing each sub-task may be same or different. For example, USD 5 for a first sub-task, USD 7 for a second sub-task, USD 4 for a third sub-task, USD 10 for a fourth sub-task, and USD 8 for a fifth sub-task. After receiving the one or more tasks and the associated one or more attributes from the requestor-computing device 102, the processor 202 may determine the set of threshold values.

Further, in an embodiment, the processor 202 may receive the one or more predefined parameters from the requestor-computing device 102. The one or more predefined parameters may correspond to a set of constraints, which may be utilized to filter out a crowd worker, from the one or more crowd workers, who may not fulfill the requirements of the requestor for processing the one or more tasks. The one or more predefined parameters may comprise one or more of, but are not limited to, an availability of a crowd worker, a count of tasks to be completed by the crowd worker, a time taken for completing the count of tasks, and a task execution time of the crowd worker. For example, a requestor, who has posted a task, may wish one or more crowd workers to be available on Friday. Further, the requestor may wish each crowd worker to complete at least five sub-tasks of the task. Further, the requestor may want the one or more crowd workers to complete task in 24 hours after acceptance of the task.

At step 304, the set of threshold values is determined. In an embodiment, the set of threshold values may be determined for each of the one or more crowd workers. In an embodiment, the processor 202 may be configured to utilize the ALU 216 to determine the set of threshold values for each of the one or more crowd workers. Prior to determining the set of threshold values, the processor 202 may extract the historical data of the one or more crowd workers from the database server 108. The historical data of each crowd worker may comprise one or more performance characteristics such as, but not limited to, a qualification, a skill set, a log of tasks completed in the past, an average time for processing a task, and an accuracy and a quality associated with the log of tasks. The one or more performance characteristics may further comprise one or more of, but are not limited to, the availability of the crowd worker on the particular day, the count of sessions on the particular day, a set of demographical attributes (e.g., name, age, location, acquaintance with other crowd workers, and/or the like) associated with the crowd worker, and a remuneration associated with the crowd worker.

After obtaining the historical data and the one or more attributes associated with the task (as discussed above), the processor 202 may determine the set of threshold values. In an embodiment, the set of threshold values is determined corresponding to the one or more predefined parameters. For example, a threshold value may be determined corresponding to an availability of a crowd worker on a particular day. In an embodiment, the set of threshold values is determined based on at least one or more of the one or more attributes associated with the one or more tasks and the historical data associated with the one or more crowd workers. For example, a requestor posts a digitization task at 00.00 AM on May 31, 2015, on a crowdsourcing platform. The digitization task will expire at 23.59 PM on Jun. 10, 2015. The requestor further specifies that one or more crowd workers, who are available on every weekday (Monday, Tuesday, Wednesday, Thursday, and Friday) shall process the digitization task. In such a case, the processor 202 may determine the availability of a crowd worker on the weekday. In an embodiment, the processor 202 may utilize the following equations to determine the availability of the crowd worker:

Availability=Σᵢp(availability of a crowd worker on a specific day, i)*Nᵢ (1)

where,

Availability: Availability of a crowd worker;

p(availability of a crowd worker on a specific day, i): Probability of availability of a crowd worker on a specific day i; and

Nᵢ: Number of occurrences of the specific day i in a time duration of processing a task.

With respect to the ongoing example, the processor 202 may further determine a count of each of the weekday during a predefined time duration, when the crowd worker was available. For example, from the historical data of the crowd worker, the processor 202 determines that the crowd worker was available on four Mondays, five Tuesdays, three Wednesdays, seven Thursdays, and six Fridays during the predefined time duration (e.g., Mar. 1, 2015 to May 30, 2015). The processor 202 further determines that there are 13 Mondays, 13 Tuesdays, 13 Wednesdays, 13 Thursdays, and 13 Fridays during the predefined time duration. Therefore, the probability of the availability of the crowd worker on Monday is 0.307 ( 4/17=0.307). Similarly, the probabilities of the availability of the crowd worker on remaining weekdays (Tuesday, Wednesday, Thursday, and Friday) are 0.384, 0.230, 0.538, and 0.461, respectively. The processor 202 further determines that the number of occurrences of each weekday during the time duration (i.e., May 31, 2015 to Jun. 10, 2015) of processing the task is 2, 2, 2, 1, and 1, respectively. Therefore, the availability of the crowd worker on weekdays is determined as:

Availability=(0.307*2)+(0.384*2)+(0.230*2)+(0.538*1)+(0.461*1)=2.841

Similarly, the processor 202 may determine the availability of the remaining one or more crowd workers. In an embodiment, the processor 202 may utilize a standard normalization technique to normalize the availability score of the one or more crowd workers in a range [0, 1].

A person having ordinary skill in the art will understand that the scope of the disclosure is not limited to determining the set of threshold values corresponding to the availability of the one or more crowd workers. In an embodiment, the processor 202 may utilize similar methodology to determine the set of threshold values corresponding to remaining one or more predefined parameters. For example, a set of threshold values may correspond to a count of tasks to be completed by a crowd worker. The set of threshold values may further correspond to a time taken by the crowd worker to complete the tasks.

At step 306, the set of rules is generated. In an embodiment, the processor 202 may be configured to generate the set of rules based on at least the one or more attributes associated with the one or more tasks. In an embodiment, each of the set of rules are generated under one or more categories based on at least the one or more attributes associated with the one or more tasks. The one or more categories may include one or more of, but are not limited to, availability, desirability, affordability, and guarantees.

### Availability

In an embodiment, the processor 202 may formulate rules that may be configured to determine whether the one or more crowd workers are available to process the one or more tasks or not. In an embodiment, the rules may further determine whether the one or more crowd workers are available on a random basis or a regular basis. Further, the processor 202 may utilize the rules under this category to determine whether the one or more crowd workers are available for a short duration or a long duration. Further, the processor 202 may determine whether the one or more crowd workers are available based on a session duration during a day.

### Desirability

A desirability category may include rules that may be utilized by the processor 202 to filter the one or more crowd workers based on the qualifications of the one or more crowd workers required to process the one or more tasks, the skill set of the one or more crowd workers, and the demographic attributes of the one or more crowd workers.

### Affordability

An affordability category may include rules that may be utilized by the processor 202 to filter the one or more crowd workers based on at least the cost associated with the one or more tasks posted by the requestor. For example, a crowd worker may be affordable, when a payment/incentive expected by the crowd worker is less than or equal to the payment/incentive offered by requestor in exchange of processing a task.

### Guarantees

A guarantees category may include rules that may be utilized by the processor 202 to filter the one or more crowd workers based on at least the time duration associated with the one or more tasks or the accuracy of the one or more tasks required by the requestor. For example, the processor 202 may filter out crowd workers, from the one or more crowd workers, if a time duration required by the crowd workers to process a task is more than the time duration specified by a requestor. Further, the processor 202 may filter out the crowd workers if an accuracy of the crowd workers on tasks processed in the past is less than the accuracy specified by the requestor. Further, the processor 202 may filter out the crowd workers based on loyalty of the one or more crowd workers. The one or more crowd workers may be loyal, when the one or more crowd workers are regularly working on the tasks posted by a same requestor.

In an embodiment, the processor 202 may utilize a predefined syntax to generate the set of rules. The predefined syntax may comprise one or more components such as, but not limited to, constructs, objects, operations, and operators. The one or more components are as shown in Table 2.

TABLE 2
Components of a rule language

| | |
|---|---|
| Constructs | IF, THEN, AND (Conjunction), OR (Disjunction) |
| Objects | Crowd worker, Task, Requestor |
| Operations | Assert, Set, Average, Min, Max |
| Operators | >, <, >=, <=, =, !=, [symbol] , C, [symbol] , [symbol] |

In an embodiment, the processor 202 may utilize the following generic syntax to generate the one or more rules of the set of rules.
Construct {([Object] [Operator] variable_name <value> [Operator] variable_name <value> [Operator] . . . )}
{Construct {([Object] [Operator] variable_name <value> [Operator] variable_name <value> [Operator] . . . )} . . . }
Construct {(Operation ((object.variable Operator object.variable) [Operator] (object.variable Operator object.variable)) . . . )}.

For example, the one or more rules may be represented as shown in Table 3.

TABLE 3
Set of rules

| Categories | Rules |
|---|---|
| Availability | R0: Session duration of worker |
| | IF (Worker [symbol] worker_id <WORKER_ID> [symbol] |
| | session_duration<WORKER_SESSION_TIME>) |
| | AND |
| | (Task [symbol] task_id<TASK_ID> [symbol] |
| | session_duration<TASK_SESSION_DURATION>) |
| | THEN (Assert(Worker.session_duration >= |
| | Task.session_duration)with some probability) |
| | R1: Random worker |
| | IF (Worker [symbol] worker_id <WORKER_ID> [symbol] |
| | is_available<IS_WORKER_AVAILABLE>) |
| | THEN (Assert(Worker.is_available == TRUE)) |
| Desirability | R2: Qualifications |
| | IF (Worker [symbol] worker_id <WORKER_ID> ) |
| | AND |
| | (Task [symbol] task_id<TASK_ID> [symbol] |
| | pre_requisite_task_done<PRE_REQ_TASK_COMPLETED>) |
| | THEN (Assert(Task.pre_requisite_task_done =1))) |
| | AND (Worker [symbol] worker_id <WORKER_ID> [symbol] worker.qualifications |
| | <PRE_REQ_TASK_COMPLETED>)) |
| | AND (Assert (worker.qualifications =1 )) |
| | R3: Skill Set |
| | IF (Worker [symbol] worker_id <WORKER_ID> [symbol] skill_set |
| | <WORKER_SKILL_SET>) |
| | AND |
| | (Task [symbol] task_id <TASK_ID> [symbol] |
| | skillset_required<TASK_SKILL_SET_REQD>) |
| | THEN (Assert(worker.skill_set [symbol] = task.skillset_required)) |
| | R4: Demography |
| | IF (Worker [symbol] worker_id <WORKER_ID> [symbol] demography |
| | <WORKER_DEMOGRAPHY>) |
| | AND |
| | (Task [symbol] task_id <TASK_ID> [symbol] |
| | demography_required<TASK_DEMOGRAPHY_REQD>) |
| | THEN (Assert(worker.demography = task.demography_required) |
| | R5: Regular worker |
| | IF (Worker [symbol] worker_id <WORKER_ID> [symbol] |
| | is_available<IS_WORKER_AVAILABLE>) |
| | THEN (Assert((Worker.is_available |
| | >=P(Worker.Availability)) [symbol] P(Worker.Availability) > 0.5)) |
| Affordability | R6: Affordability |
| | IF (Worker [symbol] worker_id <WORKER_ID> [symbol] |
| | payment_expected<WORKER_PAYMENT_EXPECTED>) |
| | AND |
| | (Task [symbol] task_id <TASK_ID> [symbol] |
| | task_payment<PAYMENT_FOR_TASK>) |
| | THEN (Assert(worker.payment_expectecd <= |
| | task.task_payment)) |
| Guarantees | R7: Throughput |
| | IF (Worker [symbol] worker_id <WORKER_ID> [symbol] no_of_tasks_perday |
| | <WORKER_TASKS_PERDAY>) |
| | AND |
| | (Task [symbol] avg_tasks_perday = Average(worker.no_of_tasks)) |
| | THEN (Assert(worker.no_of_tasks >= avg_tasks_perday)) |
| | R8: Loyalty |
| | IF (Worker [symbol] worker_id <WORKER_ID> [symbol] |
| | no_hits_executed<WORKER_HITS_EXECUTED>) |
| | AND |
| | (Requestor [symbol] requestor_id <REQUESTOR_ID> [symbol] |
| | no_tasks_posted <NO_TASKS_POSTED> [symbol] days_tasks_posted |
| | <DAYS_TASKS_POSTED>) |
| | THEN (Assert(worker. no_hits_executed >=((0.8 * |
| | requestor.no_tasks_posted ) [symbol] |
| | (0.9 * requestor.days_task_posted)))) |
| | AND (Set(worker.is_loyal =1)) |
| | R9: Task Execution Time |
| | IF (Worker [symbol] worker_id <WORKER_ID> [symbol] |
| | execution_time<WORKER_EXECUTION_TIME>) |
| | AND |
| | (Requestor [symbol] requestor_id <REQUESTOR_ID> [symbol] |
| | expected_exec_time<EXPECTED_EXEC_TIME)>) |
| | THEN (Assert(worker.execution_time <= requestor. |
| | expected_exec_time)) |
| | R10: Approval Rate |
| | IF (Worker [symbol] worker_id <WORKER_ID> [symbol] |
| | approval_rate<WORKER_APPROVAL_RATE>) |
| | AND |
| | (Requestor [symbol] requestor_id <REQUESTOR_ID> [symbol] |
| | expected_approval_rate<EXPECTED_APPROVAL_RATE>) |
| | THEN(Assert(worker. approval_rate >= requestor. |
| | expected_approval_rate)) |

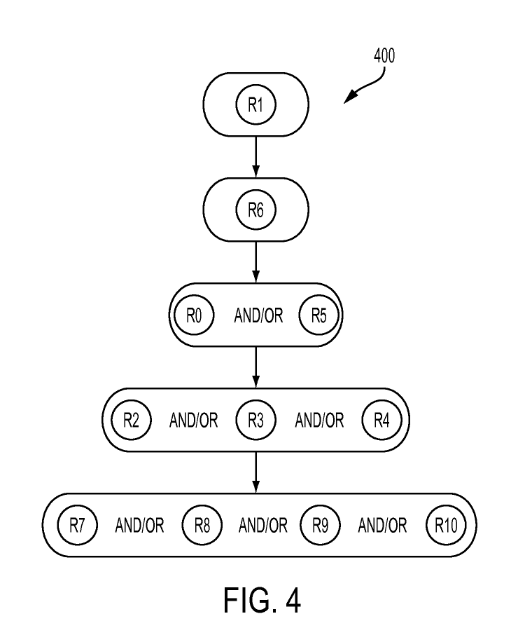

After determining the set of rules, the processor 202 may be configured to store each of the set of rules in the hierarchal data structure. The set of rules are stored in the hierarchal data structure based on at least the priority associated with each of the set of rules. In an embodiment, the processor 202 may assign the priority to each of the set of rules based on at least the one or more preferences, for the one or more performance characteristics, the one or more predefined parameters or the one or more attributes, received from the requestor-computing device 102. For example, a requestor may prefer availability of a crowd worker over affordability of the crowd worker. In such a case, the processor 202 may assign a higher priority to a rule based on availability and a lower priority to a rule based on affordability. Similarly, the processor 202 may assign the priority to each of the set of rules. Thereafter, the processor 202 may arrange the set of rules in the hierarchal data structure based on at least the priority. FIG. 4 shows an illustrative example of an arrangement of the set of rules in the hierarchal data structure. As shown in FIG. 4, the hierarchal data structure may comprise a plurality of levels, such that each level may include at least one rule from the set of rules. After determining the hierarchal data structure, the processor 202 may utilize the set of rules stored in the hierarchal data structure to select the first set of crowd workers.

At step 308, the first set of crowd workers are selected from the one or more crowd workers. In an embodiment, the processor 202 may be configured to select the first set of crowd workers from the one or more crowd workers. In an embodiment, the processor 202 may select the first set of crowd workers based on at least the triggering of the one or more rules in the set of rules. In an embodiment, the processor 202 may utilize the set of threshold values to trigger the one or more rules in a sequential order as depicted in the hierarchal data structure. In an embodiment, the processor 202 may execute the one or more rules at each level of the hierarchal data structure to filter out crowd workers, from the one or more crowd workers, who may not fit into the requirements of the requestor to process the one or more tasks.

After the execution of the one or more rules in the hierarchal data structure, the first set of crowd workers is obtained, who may work upon the one or more tasks. For example, there are 100 crowd workers. A requestor posts a task. As per requirements of the requestor, the crowd workers should be available on Friday (high priority). Further, the crowd workers should possess image processing skill (low priority). Further, a cost associated with each of the crowd workers should be at most USD 15 (medium priority). Thereafter, the processor 202 may check for the crowd workers (among the 100 crowd workers), who may be available on Friday. Out of 100 crowd workers, 75 crowd workers are available on Friday. In such a case, the processor 202 may filter out 25 crowd workers, who are not available on Friday. Thereafter, the processor 202 may check for the crowd workers (among the 75 crowd workers), who may charge less or equal to USD 15. Out of 75 crowd workers, 45 crowd workers charge less than or equal to USD 15. In such a case, the processor 202 may filter out 30 crowd workers, who charges more than USD 15 for processing the task. Thereafter, the processor 202 may check for the crowd workers (among 45 crowd workers), who may possess the image processing skill. Out of 45 crowd workers, 15 crowd workers possess the image processing skill. In such a case, the processor 202 may filter out 30 crowd workers, who may not be possessing the image processing skill. Thus, a first set of crowd workers may comprise 15 crowd workers, who may be eligible to work upon the task according to the requirements of the requestor.

At step 310, the first score is determined for each of the first set of crowd workers. The first score may correspond to the Human Performance Index (HPI). The first score may be indicative of whether a first crowd worker, from the first set of crowd workers, is more efficient that the remaining first crowd workers from the first set of crowd workers. In an embodiment, the processor 202 may be configured to determine the first score based on at least the one or more attributes (associated with the one or more tasks) specified by the requestor. For an attribute specified by the requestor, the processor 202 may determine the first score by utilizing at least two factor: (1) mean or average value of the attribute and (2) probability (confidence) with which the attribute value is determined. In an embodiment, the processor 202 may utilize the following equations to determine the first score:

first score=Σᵢ wᵢ*mᵢ (2)

where,

w: represents a weight; and

m: represents a mean of an attribute.

In an embodiment, the processor 202 may utilize the following equations to determine the weight. In an embodiment, the processor 202 may utilize a value of mean and standard deviation to determine a confidence interval of the values with 95% confidence. The confidence interval is determined as follows:

$$\begin{matrix}\{ L , H \} = mean \{ + , - \} * \frac{1.96 * σ}{\sqrt{n}} & ( 3 ) \\ i . e . \\ \{ L \} = mean - \frac{1.96 * σ}{\sqrt{n}} , \\ and & ( 4 ) \\ \{ H \} = mean + \frac{1.96 * σ}{\sqrt{n}} & ( 5 )\end{matrix}$$

where,

σ: represents a standard deviation;

n: represents a total population; and

{L, H}: represents a range {low, high} within which the value of the attribute will lie with 95% confidence.

The weight is determined by use of following equation:

$$w = \frac{1}{( H - L )} \qquad ( 6 )$$

In an embodiment, the processor 202 may normalize the first score so that the first score may lie between 0 and 1. In such a case, the processor 202 may utilize the following equation to normalize the first score:

$$normalized first score = \frac{first score}{max ( first score )} \qquad ( 7 )$$

For example, a requestor specifies to compute a first score based on an availability of a crowd worker on weekdays and a number of tasks the crowd worker is expected to complete. The requestor further specifies to consider historical data for the month of April and May. The availability of the crowd worker during weekdays (i.e., Monday, Tuesday, Wednesday, Thursday, Friday) for the months of April and May is [2, 3, 1, 0, 4]. The number of tasks completed by the crowd worker during the months of April and May is [5, 6, 6, 3, 10]. The processor 202 may calculate the first score of the crowd worker as follows:

$$first score = ( {w}_{1} * {m}_{1} ) + ( {w}_{2} * {m}_{2} )$$

$${m}_{1} = \frac{2 + 3 + 1 + 0 + 4}{5} = 2$$

$${m}_{2} = \frac{5 + 6 + 6 + 3 + 10}{5} = 6$$

$${σ}_{1} = 1.732$$

$${σ}_{2} = 2.449$$

$${L}_{1} = {m}_{1} - ( 1.96 * \frac{{σ}_{1}}{\sqrt{n}} ) = 2 - ( 1.96 * \frac{1.732}{\sqrt{5}} ) = 0.478$$

$${H}_{1} = {m}_{1} + ( 1.96 * \frac{{σ}_{1}}{\sqrt{n 1}} ) = 2 + ( 1.96 * \frac{1.732}{\sqrt{5}} ) = 3.521$$

$${L}_{2} = {m}_{2} - ( 1.96 * \frac{{σ}_{2}}{\sqrt{n 2}} ) = 6 - ( 1.96 * \frac{2.449}{\sqrt{5}} ) = 3.847$$

$${H}_{2} = {m}_{2} + ( 1.96 * \frac{{σ}_{2}}{\sqrt{n 2}} ) = 6 + ( 1.96 * \frac{2.449}{\sqrt{5}} ) = 8.152$$

$${w}_{1} = \frac{1}{{H}_{1} - {L}_{1}} = \frac{1}{3.521 - 0.478} = 0.3286$$

$${w}_{2} = \frac{1}{{H}_{2} - {L}_{2}} = \frac{1}{8.152 - 3.847} = 0.2322$$

$$first score = ( 0.3286 * 2 ) + ( 0.2322 * 6 ) = 2.0504$$

Similarly, the processor 202 may calculate the first score for each of the first set of crowd workers. Thereafter, the processor 202 may normalize the first score of each of the first set of crowd workers so that the first score may lie between at least [0, 1]. For example, the first scores of three crowd workers (e.g., CW-A, CW-B, and CW-C) are 2.0504, 1.5987, and 2.8654, respectively. In such a case, the normalized first scores are determined as follows:

$$normalized first score of CW - A = \frac{first score of CW - A}{max ( first score )} = \frac{2.0504}{2.8664} = 0.7155$$

$$normalized first score of CW - B = \frac{first score of CW - B}{max ( first score )} = \frac{1.5987}{2.8654} = 0.5579$$

$$normalized first score of CW - C = \frac{first score of CW - C}{max ( first score )} = \frac{2.8654}{2.8654} = 1$$

At step 312, the resource graph is generated based on at least the first score associated with the each of the first set of crowd workers. In an embodiment, the processor 202 may generate the resource graph based on at least the first score associated with each of the first set of crowd workers. For example, a first set of crowd workers includes seven crowd workers. The normalized first score of each of the seven crowd workers is 0.17, 0.19, 0.35, 039, 0337, 0.75, and 0.9, respectively. The processor 202 categorizes the first set of crowd workers under three categories (e.g., a first category, a second category, and a third category). The first category includes crowd workers having normalized first score in a range (0-0.3). The second category includes crowd workers having normalized first score in a range (0.3-0.7). The third category includes crowd workers having normalized first score in a range (0.7-1). An illustrative resource graph 500 with respect to the ongoing example has been shown in FIG. 5. The resource graph may correspond to a bar graph as shown in FIG. 5. Each bar in the resource graph represents a count of crowd workers in a particular range (HPI range).

At step 314, the resource graph is displayed on the display screen of the requestor-computing device 102. In an embodiment, the processor 202 may present the GUI, displaying the resource graph, on the display screen of the requestor-computing device 102. The requestor may utilize the resource graph to view the first set of crowd workers, who may work upon the one or more tasks.

At step 316, the requestor is enabled to select the second set of crowd workers. The second set of crowd workers may correspond to the crowd workforce, who may work upon the one or more tasks. In an embodiment, the processor 202 may enable the requestor of the requestor-computing device 102 to select the second set of crowd workers from the first set of crowd workers. In an embodiment, the requestor may utilize the resource graph to select the second set of crowd workers based on at least the first score associated with each of the first set of crowd workers. For example, a resource graph as shown in FIG. 5 is displayed to a requestor. The requestor may click on a particular bar associated with a particular HPI range in the resource graph. Thereafter, the requestor may be able to view first scores (HPI) of the crowd workers associated with the selected bar. Similarly, the requestor may view the first score of each of the first set of crowd workers. Thereafter, the requestor may select the second set of crowd workers, from the first set of crowd workers, based on at least the first score associated with each of the first set of crowd workers. For example, the requestor may select the crowd workers in the range (0.7, 1) as the second set of crowd workers.

After selecting the second set of crowd workers, the requestor may communicate with the selected second set of crowd workers over the network 112. Further, the requestor may transmit or share the one or more tasks and the SLAs associated with each of the one or more tasks with the selected second set of crowd workers. Each of the second set of crowd workers may utilize the crowd worker-computing device 104 to work upon the one or more tasks. After completing the one or more tasks, the second set of crowd workers may submit the one or more responses corresponding to the one or more tasks to the requestor over the network 112. The requestor may validate the one or more responses received from the second set of crowd workers. Thereafter, the requestor may initiate the payment to the second set of crowd workers based on at least the validation.

FIG. 4 is a block diagram of the hierarchal data structure illustrating the set of rules, in accordance with at least one embodiment. The hierarchal data structure may comprise at least a plurality of levels. Each level, from the plurality of levels, may comprise the one or more rules from the set of rules. Further, in an embodiment, each of the one or more rules at each of the plurality of levels may be processed in a sequence as shown in FIG. 4. For example, as shown in FIG. 4, the processor 202 may utilize a rule (depicted by R1) to filter out one or more crowd workers. Similarly, the processor 202 may utilize a rule (depicted by R6) to filter out the one or more crowd workers. The processor 202 may continue filtering the one or more crowd workers (by utilizing the one or more rules in the hierarchal data structure) till requirements of the requestor is met.

A person having ordinary skills in the art will understand that the scope of the disclosure is not limited the hierarchal data structure as shown in FIG. 4. FIG. 4 depicts an example block diagram comprising the one or more rules at each of the plurality of levels. The one or more rules, from the set of rules, at each level may vary according to the one or more preferences for the one or more predefined parameters (or the one or more attributes associated with one or more tasks) received from the requestor.

FIG. 5 is an illustrative example displaying the resource graph, in accordance with at least one embodiment. In an embodiment, the processor 202 may generate the resource graph 500 based on at least the first set of crowd workers and the first score (Human Performance Index) associated with each of the first set of crowd workers. In an embodiment, the processor 202 may present the resource graph 500 on the display screen of the requestor-computing device 102. Further, in an embodiment, the requestor may utilize the resource graph 500 to select the second set of crowd workers, who may work upon the one or more tasks.

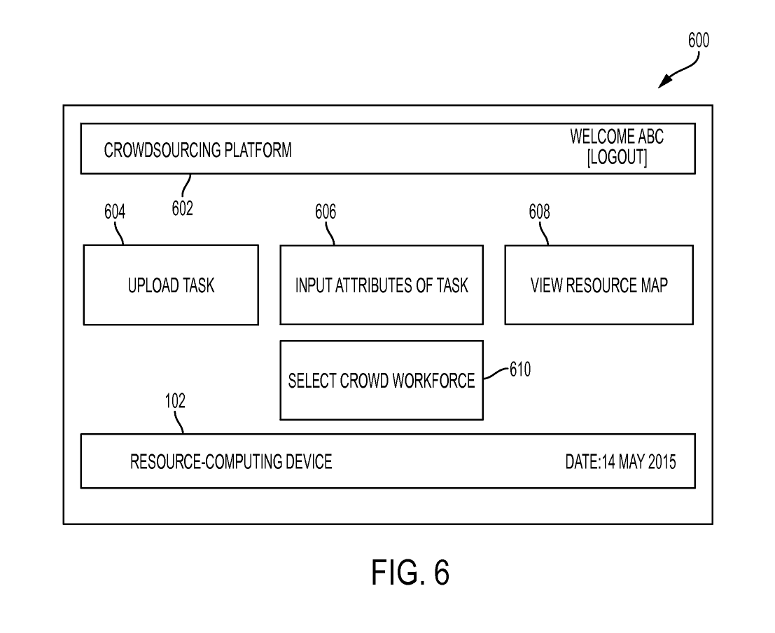

FIG. 6 is a block diagram illustrating an example graphical user-interface (GUI) 600 that may be utilized by the requestor to initiate the selection of the crowd workforce for processing the one or more tasks, in accordance with at least one embodiment. The GUI 600 may be displayed on a display screen of a computing device such as the requestor-computing device 102. The requestor may log into a crowdsourcing platform 602 using his/her user ID and password. The processor 202 may present the GUI 600 on the requestor-computing device 102, when the user may have logged in. The requestor may click on a tab such as upload task tab 604 to upload or post the one or more tasks. Further, the requestor may click on a tab such as input attributes of task tab 606 to upload the one or more attributes associated with the one or more tasks. Further, the requestor may click on a tab such as view resource map tab 608 to view the resource map of the first set of crowd workers. Thereafter, the requestor may click on a tab such as select crowd workforce tab 610 to select the second set of crowd workers from the first set of crowd workers. The requestor may utilize the resource graph to select the second set of crowd workers.

The disclosed embodiments encompass numerous advantages. The disclosure provides for selecting the crowd workforce, who may work upon the one or more tasks posted or shared by the requestor. The disclosed method utilizes the one or more attributes (i.e., the requirements) provided by the requestor to generate the set of rules. The disclosed method further utilizes the set of rules to filter out the crowd workers, from the one or more crowd workers, who may not fit into the requirements of the requestor to process the one or more tasks. Thereafter, the disclosed method generate the resource graph based on the HPI of the selected first set of crowd workers. The disclosed method further displays the resource graph to the requestor. The requestor utilizes the resource graph to select the second set of crowd workers (i.e., the crowd workforce). The requestor may further communicate with the crowd workforce to negotiate the terms and conditions of the Service Level Agreement (SLA) associated with the processing of the one or more tasks.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for selecting a crowd workforce for processing a task have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for selecting a crowd workforce for processing a task, said method comprising:
receiving, by one or more processors, said task and one or more attributes associated with said task from a requestor-computing device;
generating, by said one or more processors, a set of rules based on at least said one or more attributes associated with said task, wherein said set of rules are stored in a hierarchal data structure based on at least a priority associated with each of said set of rules;
selecting, by said one or more processors, a first set of crowd workers, from one or more crowd workers, based on at least a triggering of one or more rules from said set of rules, wherein said triggering of said one or more rules is based on at least said hierarchal data structure and at least a set of threshold values associated with said one or more crowd workers; and
displaying, by said one or more processors, a resource graph on a display screen of said requestor-computing device associated with a requestor, wherein said resource graph represents at least said first set of crowd workers.

2. The method of claim 1 further comprising receiving, by said one or more processors, said one or more attributes associated with said task, wherein said one or more attributes comprise at least a type of said task, a skill set required to process said task, and a Service Level Agreement (SLA) associated with said task, wherein said SLA includes at least a task completion time, an accuracy, a count of tasks to be completed in a predefined time, an expected quality of said task, and a remuneration associated with said task.

3. The method of claim 1 further comprising extracting, by said one or more processors, a historical data comprising one or more performance characteristics associated with each of said one or more crowd workers, wherein said one or more performance characteristics associated with each crowd worker comprise at least a qualification of said each crowd worker, a skill set of said each crowd worker, a count of tasks completed by said each crowd worker in past, an average time taken by said each crowd worker to complete each of said count of tasks, a quality of work associated with each of said count of tasks, an availability of said each crowd worker on a particular day, a count of sessions associated with said each crowd worker on said particular day, demographical attributes associated with said each crowd worker, and a remuneration charged for each of said count of tasks by said each crowd worker.

4. The method of claim 3 further comprising determining, by said one or more processors, said set of threshold values associated with said one or more crowd workers based on at least said one or more attributes associated with said task and said historical data associated with said one or more crowd workers.

5. The method of claim 4, wherein each threshold value in said set of threshold values is determined corresponding to one or more predefined parameters, wherein said one or more predefined parameters comprise at least one or more of an availability of a crowd worker on a particular day, a count of tasks to be completed by said crowd worker, a time taken for completing said count of tasks, and a task execution time of said crowd worker.

6. The method of claim 5 further comprising determining, by said one or more processors, a first score for each of said first set of crowd workers based on at least said one or more attributes, wherein said first score is indicative of whether each first crowd worker is more efficient than remaining first crowd workers from said first set of crowd workers.

7. The method of claim 6 further comprising generating, by said one or more processors, said resource graph based on at least said first score associated with each of said first set of crowd workers.

8. The method of claim 7 further comprising enabling, by said one or more processors, said requestor to select a second set of crowd workers from said first set of crowd workers, wherein said requestor utilizes said resource graph for said selection of said second set of crowd workers based on at least said first score associated with each of said first set of crowd workers.

9. The method of claim 8 further comprising communicating, by said requestor over a network, said task to said second set of crowd workers.

10. The method of claim 1 further comprising receiving, by said one or more processors, one or more preferences, for at least one or more performance characteristics associated with said one or more crowd workers, from said requestor-computing device of said requestor.

11. The method of claim 10 further comprising determining, by said one or more processors, said priority of said one or more rules from said set of rules based on at least said one or more preferences.

12. A system for selecting a crowd workforce for processing a task, said system comprising:
one or more processors configured to:
receive said task and one or more attributes associated with said task from a requestor-computing device;
generate a set of rules based on at least said one or more attributes associated with said task, wherein said set of rules are stored in a hierarchal data structure based on at least a priority associated with each of said set of rules;
select a first set of crowd workers, from one or more crowd workers, based on at least a triggering of one or more rules from said set of rules, wherein said triggering of said one or more rules is based on at least said hierarchal data structure and at least a set of threshold values associated with said one or more crowd workers; and
display a resource graph on a display screen of said requestor-computing device associated with a requestor, wherein said resource graph represents at least said first set of crowd workers.

13. The system of claim 12, wherein said one or more processors are further configured to receive said one or more attributes associated with said task, wherein said one or more attributes comprise at least a type of said task, a skill set required to process said task, and a Service Level Agreement (SLA) associated with said task, wherein said SLA includes at least a task completion time, an accuracy, a count of tasks to be completed in a predefined time, an expected quality of said task, and a remuneration associated with said task.

14. The system of claim 12, wherein said one or more processors are further configured to determine said set of threshold values associated with said one or more crowd workers based on at least said one or more attributes associated with said task and a historical data associated with said one or more crowd workers, wherein each threshold value in said set of threshold values is determined corresponding to one or more predefined parameters.

15. The system of claim 12, wherein said one or more processors are further configured to receive one or more preferences, for at least one or more performance characteristics associated with said one or more crowd workers, from said requestor-computing device of said requestor.

16. The system of claim 15, wherein said one or more processors are further configured to determine said priority of said one or more rules from said set of rules based on at least said one or more preferences.

17. The system of claim 12, wherein said one or more processors are further configured to determine a first score for each of said first set of crowd workers based on at least one or more attributes, wherein said first score is indicative of whether each first crowd worker is more efficient than remaining first crowd workers from said first set of crowd workers.

18. The system of claim 17, wherein said one or more processors are further configured to generate said resource graph based on at least said first score associated with each of said first set of crowd workers.

19. The system of claim 18, wherein said one or more processors are further configured to enable said requestor to select a second set of crowd workers from said first set of crowd workers, wherein said requestor utilizes said resource graph for said selection of said second set of crowd workers based on at least said first score associated with each of said first set of crowd workers.

20. A computer program product for use with a computer, the computer program product comprising a non-transitory computer readable medium, wherein the non-transitory computer readable medium stores a computer program code for selecting a crowd workforce for processing a task, wherein the computer program code is executable by one or more processors to:
receive an input, indicative of at least a request to process said task, from a requestor-computing device, wherein said task is associated with one or more attributes;
generate a set of rules based on at least said one or more attributes associated with said task, wherein said set of rules are stored in a hierarchal data structure based on at least a priority associated with each of said set of rules;
select a first set of crowd workers, from one or more crowd workers, based on at least a triggering of one or more rules from said set of rules, wherein said triggering of said one or more rules is based on at least said hierarchal data structure and at least a set of threshold values associated with said one or more crowd workers; and
display a resource graph on a display screen of said requestor-computing device associated with a requestor, wherein said resource graph represents at least said first set of crowd workers.
